(19) United States
(12) Patent Application Publication
(10) Pub. No.: US 2018/0010671 A1
(43) Pub. Date: Jan. 11, 2018

(54) Tensioner

(71) Applicant: GATES CORPORATION, Denver, CO (US)

(72) Inventors: Xiaohua Joe Chen, Windsor (CA); Oliver Stegelmann, Strathroy (CA); Piotr Dec, Harrow (CA); Rudy Pupulin, Tecumseh (CA); Wanzhi Han, Windsor (CA)

(21) Appl. No.: 15/203,408

(22) Filed: Jul. 6, 2016

(51) Int. Cl. F16H 7/12; F16H 7/08

(52) U.S. Cl. CPC F16H 7/1281; F16H 2007/0893; F16H 2007/081; F16H 2007/0842; F16H 2007/0865

(57) ABSTRACT

A tensioner comprising a base, a shaft press fit into the base, a pivot arm journalled to the shaft, the pivot arm having a first frustoconical portion and a frustoconical bushing disposed thereon, a pulley journalled to the pivot arm, a torsion spring engaged between the base and the pivot arm for biasing the pivot arm, a seal disposed between the base and pivot arm on the shaft, the shaft comprising a second frustoconical portion describing an apex angle Δ, and the torsion spring applying an axial spring force to the pivot arm such that the first frustoconical portion is in pressing engagement with the second frustoconical portion.

### FIELD OF THE INVENTION

The invention relates to a tensioner, and more particularly, to a tensioner having a frustoconical shaft press fit to a base.

### BACKGROUND OF THE INVENTION

Most engines used for automobiles and the like include a number of belt driven accessory systems which are necessary for the proper operation of the vehicle. The accessory systems may include an alternator, air conditioner compressor and a power steering pump.

The accessory systems are generally mounted on a front surface of the engine. Each accessory has a pulley mounted on a shaft for receiving power from some form of belt drive. In early systems, each accessory was driven by a separate belt that ran between the accessory and the crankshaft. Due to improvements in belt technology, single serpentine belts are now generally used in most applications. A single serpentine belt routed among the various accessory components drives the accessories. The engine crankshaft drives the serpentine belt.

Since the serpentine belt must be routed to all accessories, it has generally become longer than its predecessors. To operate properly, the belt is installed with a pre-determined tension. As it operates, it stretches slightly over its length. This results in a decrease in belt tension, which may cause the belt to slip. Consequently, a belt tensioner is used to maintain the proper belt tension as the belt stretches during use.

As a belt tensioner operates, the running belt may excite oscillations in the tensioner spring. These oscillations are undesirable, as they cause premature wear of the belt and tensioner. Therefore, a damping mechanism is added to the tensioner to damp operational oscillations.

Various damping mechanisms have been developed. They include viscous fluid dampers, mechanisms based on frictional surfaces sliding or interaction with each other, and dampers using a series of interacting springs. For the most part these damping mechanisms operate in a single direction by resisting a movement of a belt in one direction. This generally resulted in undamped vibrations existing in a belt during operation as the tensioner arm oscillated between loaded and unloaded positions.

Representative of the art is U.S. Pat. No. 4,698,049 which discloses a belt tensioner in which the bearing for mounting the pulley carrying pivoted structure on the fixed structure comprises a frustoconical sleeve bearing having a frustoconical exterior surface and a frustoconical interior surface engaged between annular portions of the two structures. The frustoconical surface of one of the annular portions is (1) formed on the exterior periphery thereof and (2) disposed in engagement with the interior bearing frustoconical surface. The one annular portion has a load center point disposed on the pivotal axis of the pivoted structure. The other annular portion has a load center point disposed on a line disposed within a plane passing through the pivotal axis of the pivoted structure and the rotational axis of the pulley corresponding to the one line of the two lines of intersection of the bearing frustoconical surface with the plane through which the radially inward force component transmitted by the pivoted structure is applied to the sleeve bearing. The load center points are positioned such that the radially inward force component transmitted by the pivoted structure and resisted by the fixed structure is transmitted generally from one load center point to the other along a line extending between the points which line is perpendicular to and bisects the one line so that the radially inward force component transmitted by the pivoted structure to the sleeve bearing is distributed evenly throughout the axial extent of the sleeve bearing.

What is needed is a tensioner having a frustoconical shaft press fit to a base. The present invention meets this need.

### SUMMARY OF THE INVENTION

The primary aspect of the invention is to provide a tensioner having a frustoconical shaft press fit to a base.

Other aspects of the invention will be pointed out or made obvious by the following description of the invention and the accompanying drawings.

The invention comprises a tensioner comprising a base, a shaft press fit into the base, a pivot arm journalled to the shaft, the pivot arm having a first frustoconical portion and a frustoconical bushing disposed thereon, a pulley journalled to the pivot arm, a torsion spring engaged between the base and the pivot arm for biasing the pivot arm, a seal disposed between the base and pivot arm on the shaft, the shaft comprising a second frustoconical portion describing an apex angle Δ, and the torsion spring applying an axial spring force to the pivot arm such that the first frustoconical portion is in pressing engagement with the second frustoconical portion.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view of the tensioner.

FIG. 2 is a cross-sectional view of the tensioner.

FIG. 3 is an exploded view of the tensioner.

FIG. 4 is a load schematic of the tensioner.

### DETAILED DESCRIPTION OF THE PREFERRED EMBODIMENT

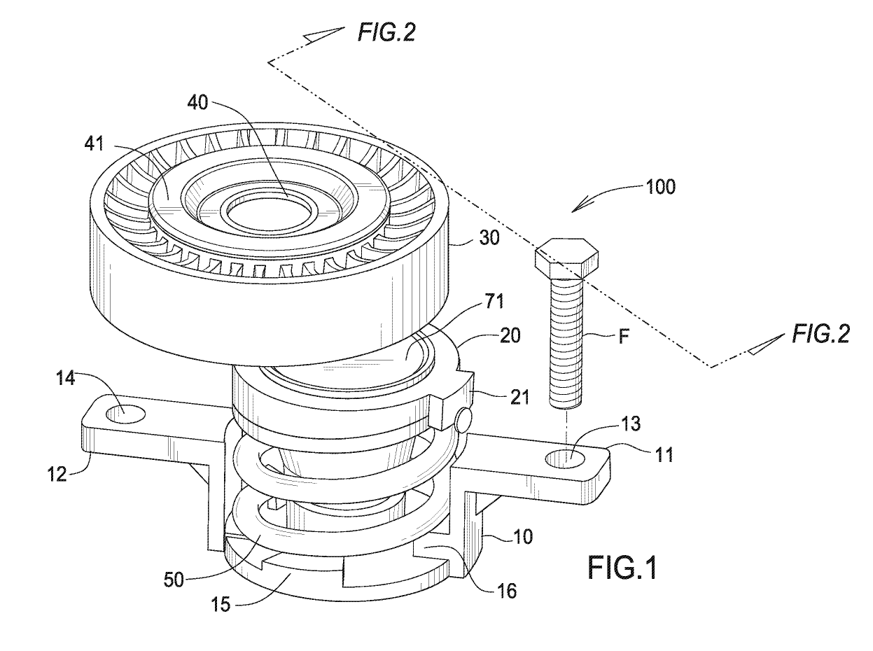

FIG. 1 is a perspective view of the tensioner.

Tensioner 100 comprises base 10, pivot arm 20, pulley 30, bearing 40 and torsion spring 50. Torsion spring 50 biases pivot arm 20 toward a belt (not shown) in order to apply a belt load. Torsion spring 50 has a spring rate selected by a user.

Pivot arm 20 is pivotally mounted to base 10. Pulley 30 is journalled to pivot arm 20 by a bearing 40. Pulley 30 engages a belt (not shown).

Base 10 comprises mounting members 11 and 12. Each mounting member comprises a hole 13, 14 respectively for receiving a fastener (F).

A volute of torsion spring 50 rests upon projections 15, 16. Each projection 15, 16 supports the volute to reduce distortion during operation.

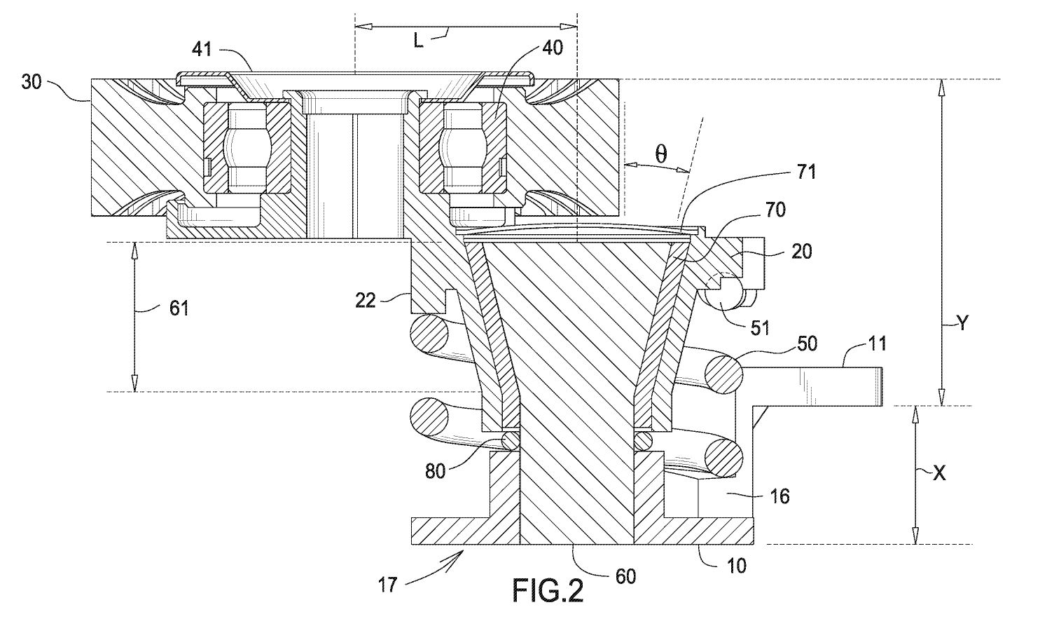

FIG. 2 is a cross-sectional view of the tensioner. Pivot arm 20 pivots about shaft 60. Shaft 60 is press fit into receiving portion 17 of base 10 which obviates the need for a separate fastener to secure the shaft to the base. This reduces cost and complexity of the inventive tensioner. Dust cover 41 protects bearing 40 from debris. An end 51 of spring 50 engages boss 21 whereby a spring force is transmitted to the pivot arm. Torsion spring 50 is loaded in the winding direction. A torsion spring volute bears upon projection 22 which extends from pivot arm 20.

Shaft 60 comprises a frustoconical portion 61. A conical angle θ is in the range of approximately 10 degrees to 30 degrees. The instant embodiment comprises a conical angle θ of 13.6 degrees.

Bushing 70 has a frustoconical shape to match the form of portion 61. Bushing 70 is disposed between pivot arm 20 and shaft 60. Pivot arm 20 pivots on bushing 70. Flexible o-ring 80 acts as a seal to prevent debris from entering between bushing 70 and portion 61. Dust cover 71 prevents debris from entering the bushing. A torsion spring volute bears upon projection 22 which extends from pivot arm 20.

In operation torsion spring 50 is in axial compression. An axial spring force (Fₛₚᵣ) presses surface of bushing 70 into surface 62 of shaft 60. The resulting frictional force between surface 72 and surface 62 damps pivotal movement of pivot arm 20. By way of example and not of limitation, an axial spring force of 605 N and a pivot arm length (L) of 29.5 mm will result in a hub load (Fₕ) of 591 N in the loading direction and 286 N in the unloading direction.

Base 10 extends a distance X below each mounting member 11, 12 which allows the tensioner to be recessed in a receiver such as a vehicle engine (not shown). This in turn decreases the required head room Y for the tensioner which in turn reduces the required engine enclosure envelope.

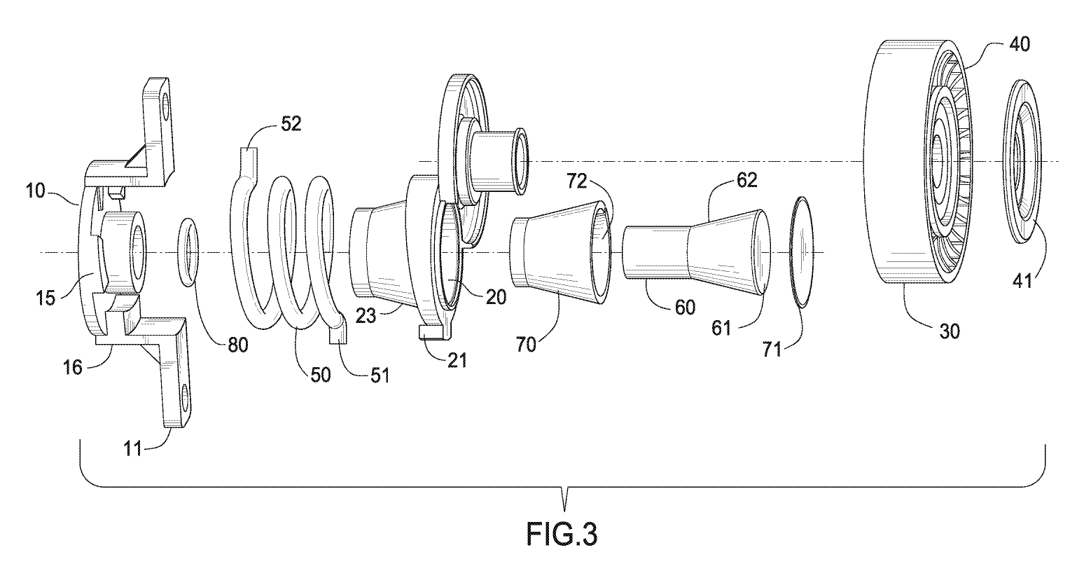

FIG. 3 is an exploded view of the tensioner. End 52 of torsion spring 50 engages base 10. Projection 15 and projection 16 support the coils of spring 50.

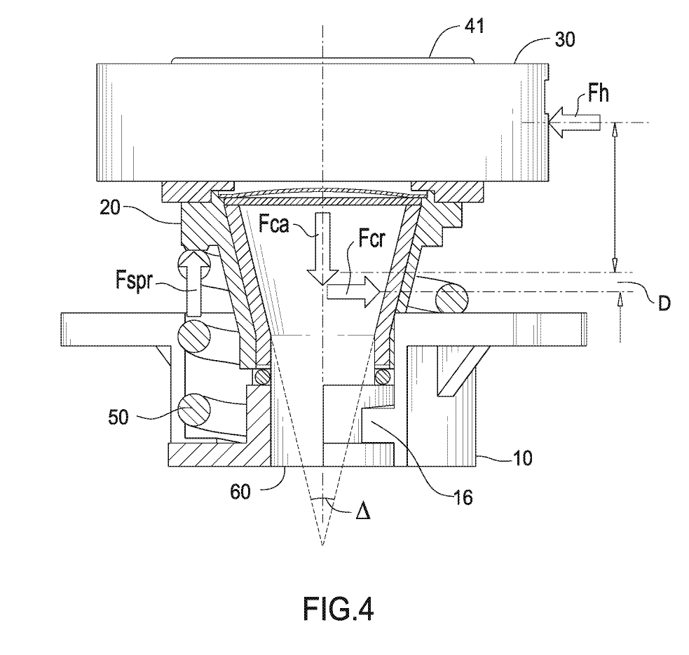

FIG. 4 is a load schematic of the tensioner. The apex of the angle Δ of the frustoconical portion 61 projects in the direction opposite the axial spring force vector Fₛₚᵣ. Fₛₚᵣ is opposite the cone axial reaction force F_{ca}. This orientation firmly engages the pivot arm frustoconical portion 23 with the shaft frustoconical portion 61. This in turn is the basis of the radial reaction force F_{cr}, a normal of which to surface 62 causes the frictional damping force between the bushing 70 and shaft surface 62. For example, in this embodiment the apex angle Δ is 27.2°. Apex angle Δ=2×θ. Bushing 70 can be fixed to either the pivot arm or the shaft.

Axial spring force vector Fₛₚᵣ created by the spring tang end 51 on the arm boss 21 is such that it provides a stabilizing force to counteract a hubload applied to pulley 30 on pivot arm 20. Hubload is the reaction force to the spring force applied to the pivot arm 20 by torsion spring 50. The magnitude and orientation of the spring reaction force Fₛₚᵣ maintains proper pulley alignment over time. As shown in FIG. 4, the cone radial reaction force F_{cr} is opposite to the hubload force Fₕ and assists with tensioner alignment due to the frustoconical shape of shaft portion 61. D is the distance between F_{cr} and the centerline of conical portion 62.

Although a form of the invention has been described herein, it will be obvious to those skilled in the art that variations may be made in the construction and relation of parts and method without departing from the spirit and scope of the invention described herein.

I claim:

1. A tensioner comprising:
a base;
a shaft press fit into the base;
a pivot arm journalled to the shaft, the pivot arm having a first frustoconical portion and a frustoconical bushing disposed thereon;
a pulley journalled to the pivot arm;
a torsion spring engaged between the base and the pivot arm for biasing the pivot arm;
a seal disposed between the base and pivot arm on the shaft;
the shaft comprising a second frustoconical portion describing an apex angle Δ; and
the torsion spring applying an axial spring force to the pivot arm such that the first frustoconical portion is in pressing engagement with the second frustoconical portion.

2. The tensioner as in claim 1, wherein the base further comprises a mounting member for receiving a fastener.

3. The tensioner as in claim 1, wherein the seal comprises an o-ring.

4. The tensioner as in claim 2, wherein the base is recessed a distance X below a mounting member.

5. The tensioner as in claim 1, wherein the torsion spring applies an axial spring force to the pivot arm in a direction opposite the direction of the apex angle Δ.

6. The tensioner as in claim 4, wherein the mounting member receives a fastener.

7. The tensioner as in claim 1, wherein the base comprises a projection for supporting the torsion spring.
